(19) United States
(12) Patent Application Publication
(10) Pub. No.: US 2025/0288488 A1
(43) Pub. Date: Sep. 18, 2025

(54) HYGENIC FOOTBATH CIRCULATOR

(71) Applicant: KENT TRAN, WEST HARTFORD, CT (US)

(72) Inventor: KENT TRAN, WEST HARTFORD, CT (US)

(21) Appl. No.: 18/769,401

(22) Filed: Jul. 11, 2024

Related U.S. Application Data
(63) Continuation-in-part of application No. 18/607,557, filed on Mar. 18, 2024.

(51) Int. Cl. A61H 33/00; A61H 35/00

(52) U.S. Cl. CPC A61H 33/60; A61H 35/006; A61H 2201/1238

(57) ABSTRACT

A circulator for use with a foot bath which comprises a perforate cover having an outlet port, a base secured to said cover having at least one upstanding stator blade intermediate said base and said cover and aligned with said outlet port, an impeller is mounted for rotation with respect to said base intermediate said base and said cover, said impeller including at least one radially extending blade, said impeller including a part thereof that is manufactured of a ferromagnetic material.

### RELATED APPLICATIONS

This application is a continuation in part application relying on the priority of U.S. patent application Ser. No. 18/607,557 filed on Mar. 18, 2024.

### PRIOR ART

Many prior art foot baths employ a circulator to circulate the fluid, that is primarily water, within a small tub. As used herein the term “tub” as used herein refers to open top imperforate container for holding liquid and usually sized for the feet of a user. In prior art apparatus a circulator within the tub is mechanically driven by a shaft extending through a seal in the wall of the tub. Thus, an external motor drives a shaft connected to a circulator within the tub. This construction does not facilitate cleaning or replacement of the circulator. Accordingly, successive users of the foot bath are exposed to microorganisms left by prior users.

It is well known that foot baths and particularly foot baths provided with a whirlpool action or water jets need to be thoroughly cleaned and disinfected to prevent the growth and spread of disease-causing microorganisms. Microorganisms can grow on moist, unclean, or contaminated surfaces.

Foot spas have been linked to bacterial outbreaks, particularly non-tuberculosis mycobacteria which can cause skin infections and inflammation of the lymph nodes. For cleaning and disinfection practices can lead to a buildup of contaminants including dirt, skin, and organic material in the filters and jets allowing microorganisms to multiply and recirculate in the foot spa water.

Cleaning and disinfection of such foot spas must be accomplished between uses of the foot spa by different individuals. It is inherent in the construction of conventional circulation devices that they include structure having intricacies that cannot be accessed adequately even if extreme precautionary cleaning measures are taken.

From the above, it is therefore seen that there exists a need in the art to overcome the deficiencies and limitations described herein and above.

### SUMMARY OF THE INVENTION

The shortcomings of the prior art are overcome and additional advantages are provided in a circulator for use with a foot bath which comprises a perforate cover having an outlet port, a base secured to said cover having at least one upstanding stator blade intermediate said base and said cover and aligned with said outlet port, an impeller is mounted for rotation with respect to said base intermediate said base and said cover, said impeller including at least one radially extending blade, said impeller including a part thereof that is manufactured of a ferromagnetic material whereby said impeller will rotate when a rotating coaxial magnetic material is disposed proximate to said impeller with magnetic engagement between said ferromagnetic material to cause said impeller to rotate; said radially extending blade directing water against said at least one stationary stator blade during each rotation whereby water is directed against at least said one stator blade and ejected from said outlet port upon impact with said stationary stator blade.

In some embodiments the cover has a circle section shape.

The cover may include an inlet proximate to the geometric center of said cover.

The apparatus may have an outlet port proximate the periphery of said cover

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is a top view of a first embodiment of the circulator apparatus in accordance with the present invention,

FIG. 2 is an isometric view of the embodiment illustrated in FIG. 1,

FIG. 3 is a side view of the embodiment illustrated in FIG. 1,

FIGS. 4-8 illustrate the upper surfaces of the sequential parts of the embodiment of the present invention, which are respectively:
a top view of the circulator housing
a top view of the rotor
a top view of an aluminum disc.
a top view of a ferrous disc.
a top view of the base

FIG. 9 is an exploded view of the same parts illustrated in FIGS. 5-9

FIG. 10 is a partly schematic view illustrating a preferred drive mechanism that facilitates the 15th the argument.

FIG. 11 is a top view of a second embodiment of the present invention in which the base and top housing are hinged together.

FIG. 12 is a bottom view of the second embodiment of the present invention in which the base and top are hinged together.

FIG. 13 is a bottom view of an assembly of the magnetic disc 22, aluminum disc 24 and the impeller 26 illustrating a viscous liquid located within a central bore of the ferrous disc whereby rotational movement of the assembly about a pin in the base disperses aroma and color to a liquid in the foot bath.

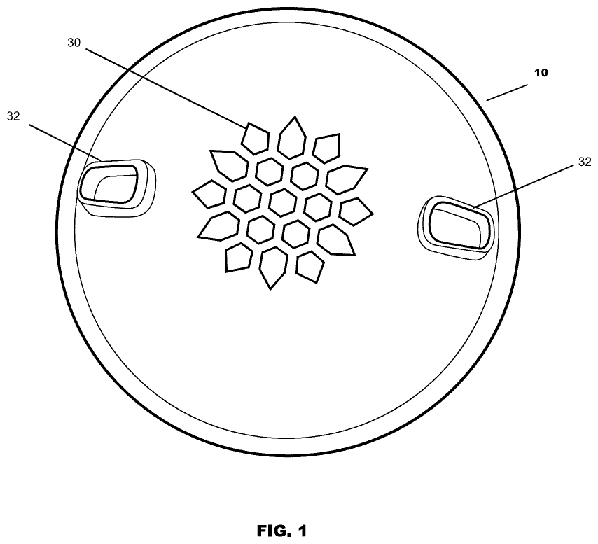

### DESCRIPTION OF THE INVENTION

Referring now to the drawing there is shown a preferred embodiment of circulator 10 secured to the side wall of a foot bath 12. Disposed on the outside of the foot bath 12 is a motor 14 having a drive shaft that carries a cylindrical magnet 16. Magnetic coupling of the magnet 16 to ferrous disc physically coupled to an impeller drives the impeller without the need for any hole in the wall of the foot bath or a seal in the wall of the foot bath to prevent leakage of the liquid out of the interior of the foot bath to the space outside of the foot bath.

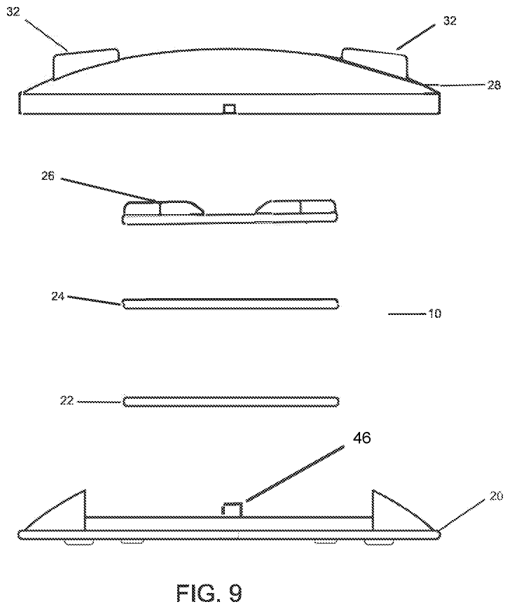

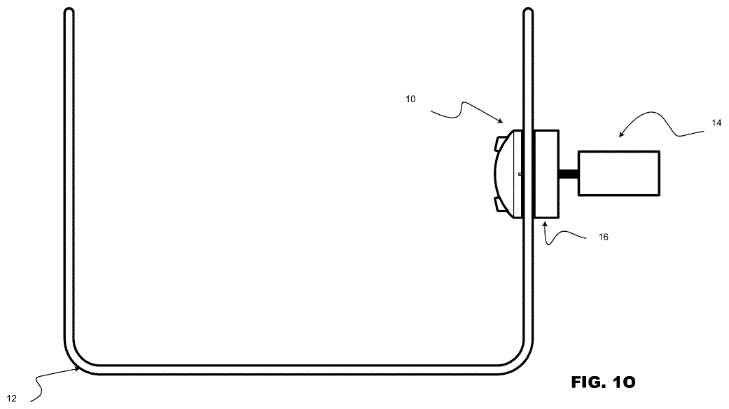

The circulator 10 as shown, for example, in FIG. 9 includes a base 20, a ferrous and therefore magnetic disk 22, and aluminum disc 24, an impeller 26 and a top cover 28. This structure is also shown in FIGS. 4-8 illustrating the top surfaces of each part in the same sequential order.

Those skilled in the art will recognize that when the circulator 10 is disposed on the interior side wall of a foot bath 12, below the level of the water in the foot bath, the openings 30 in the top of the circulator will allow ingress of the water into the foot bath. Magnetic coupling between the ferrous disc 22 which physically is attached to the impeller 26 results in the rotation of the impeller 26.

The rotation of the impeller 26 forces water in the foot bath radially along the axial extent of the radially extending impeller blades 40. As each radial blade 40 passes either stator blades 42 in the base 20, water is forced radially toward the stator blade and out an outlet 32. The respective outlets 32 are registered with respect to the stator blades 42.

It will be understood that the bore 44 of the ferrous disc 22 engage a post 46 in the base 20.

Accordingly, the apparatus in accordance with the present invention allows easy replacement of the circulator. More particularly, magnetic attraction between the magnetic disk 16 and the ferrous disc 22 all the circulator in place on the interior wall of the foot bath 12. Accordingly, each new user of a foot bath can detach the original circulator and attach a new circulator merely by placing the new circulator in magnetic communication with the magnetic to 16. There is no possibility of transmission of undesirable microbes. The simplicity and apparatus ensure that the cost of manufacturing and the cost of regularly replacing the circulator is nominal.

The description herein has referred to a disk 22 being a ferrous material. More particularly, a central bore 44 in the ferrous disk 22 engages a post 44 in the base 20. Those skilled in the art will understand that the terminology ferromagnetic material is the more complete descriptive term. That term refers to substances which are attracted to permanent magnets or are permanent magnets themselves.

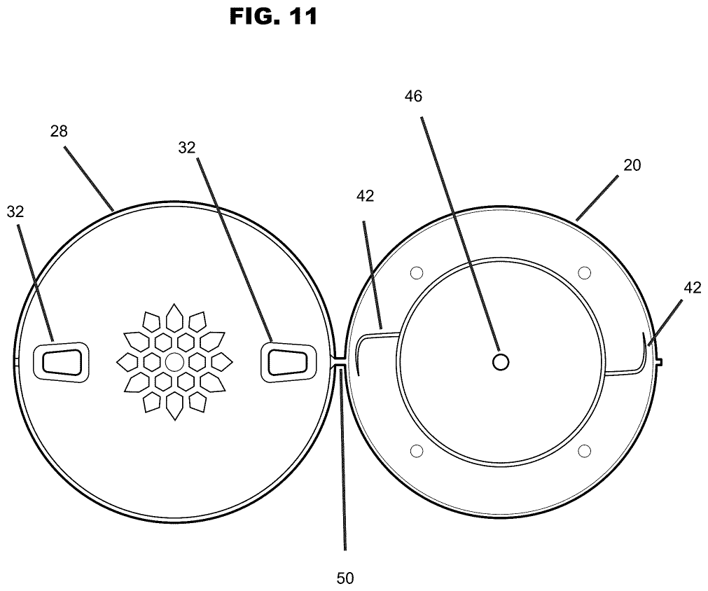

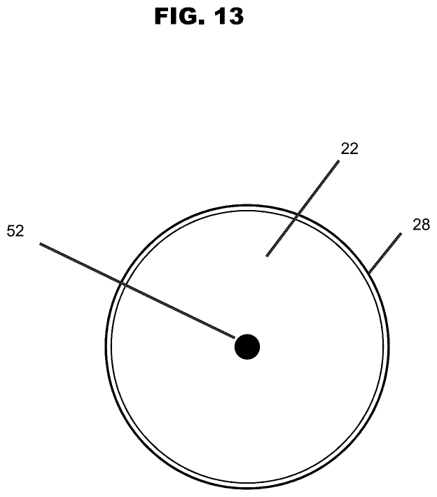

The second embodiment also includes of the above structure. As best seen in FIGS. 11 and 13 the same base 20 as shown in FIG. 9 cooperates with the same assembly of a ferrous disk 22 having central bore filled with a liquid 52 in the disk 22 engaging a post 44 in the base 20. The liquid 52 is selected for aromatic and color properties.

As viewed in FIG. 11 the second embodiment includes a flexible hinge 50 joining the top of the base 20 with the concave housing 28.

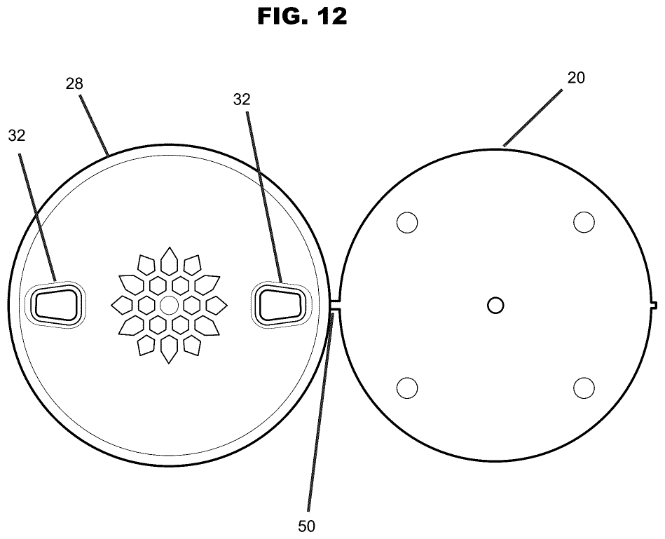

The second embodiment is further illustrated in FIG. 12 illustrating the bottom of the base 20 and the convex top face of the housing 28 joined by a flexible hinge 50.

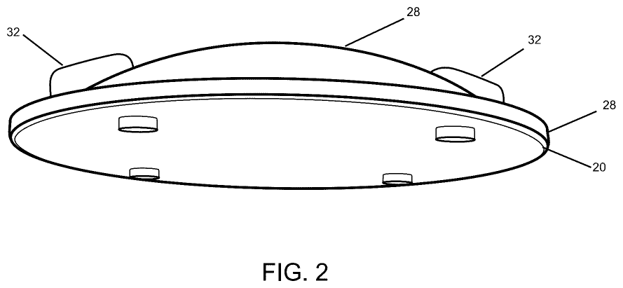

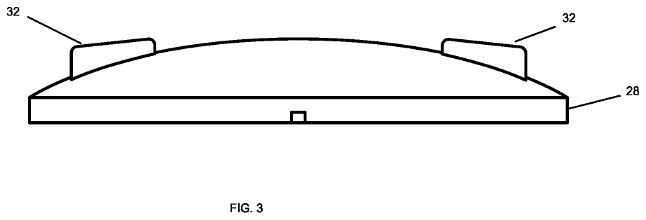

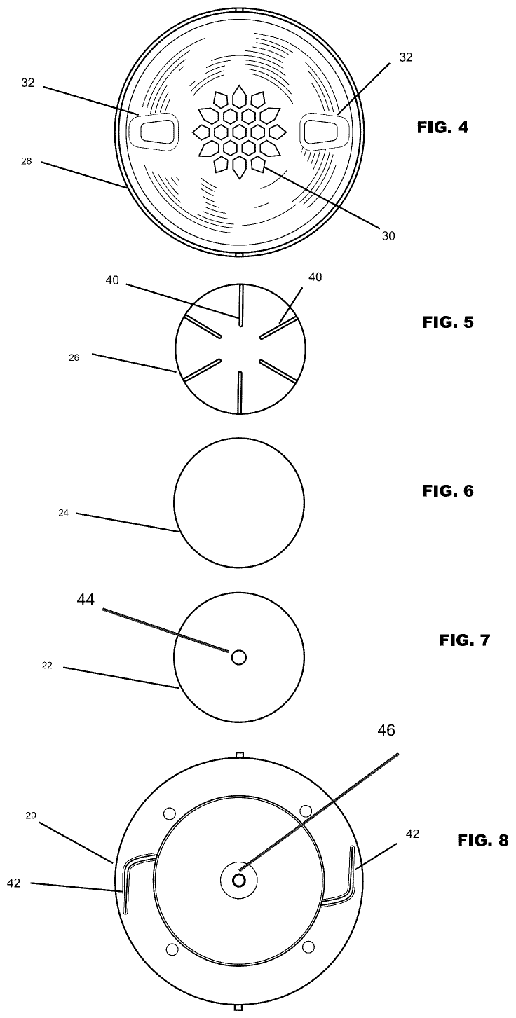

A particular advantage of the second embodiment is that assembly time is substantially reduced. More particularly, in the first embodiment the assembly of the housing 28 to the base 20 require agility and significant time. In the second embodiment the attachment of the housing 28, as shown for example in FIG. 11 to the base 20 can better automated by flipping the housing 28 from the position illustrated in FIG. 2. Because the hinge 50 precisely locates the housing 28 with respect to the base 20, automation of the assembly is possible.

A further advantage of the second embodiment is that the aromatic and color characteristics are infused into the liquid within the foot bath to establish a pleasant environment for the user.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A circulator for use with an associated imperforate foot bath which comprises:
a perforate cover having an outlet port, a base secured to said cover having at least one upstanding stator blade intermediate said base and said cover and aligned with said outlet port, an impeller is mounted for rotation with respect to said base intermediate said base and said cover, said impeller including at least one radially extending blade, said impeller including a part thereof that is manufactured of a ferromagnetic material whereby said impeller will rotate when a rotating coaxial magnetic material is disposed proximate to said impeller with magnetic engagement between said ferromagnetic material to cause said impeller to rotate; said radially extending blade directing water against said at least one stationary stator blade during each rotation whereby water is directed against at least said one stator blade and ejected from said outlet port upon impact with said stationary stator blade.

2. The apparatus as described in claim 1 wherein said cover has a spherical section shape.

3. The apparatus as described in claim 1 wherein said cover includes an inlet proximate to the geometric center of said cover.

4. The apparatus as described in claim 1 wherein said outlet port is proximate to the periphery of said cover.

5. The apparatus as described in claim 1 further including an aromatic substance disposed intermediate said impeller and said base whereby an aromatic effect is produced for users of the associated foot bath.

6. The apparatus as described in claim 1 further including a coloring substance disposed intermediate said impeller and said base whereby liquid in the associated foot bath achieves an aesthetic color impression.

7. The apparatus as described in claim 1 wherein said perforate cover has a spherical section shape.

8. A circulator for use with an associated imperforate foot bath which comprises:
a perforate cover having an outlet port,
a base having a first face dimensioned and configured for engagement with said perforate cover, said base having at least one upstanding stator blade intermediate said first face of said base and said cover and said one upstanding stator blade being aligned with said outlet port,
an impeller mounted for rotation with respect to said base intermediate said base and said cover, said impeller including at least one radially extending blade, said impeller including a part thereof that is manufactured of a ferromagnetic material whereby said impeller will rotate when a rotating coaxial magnetic material is disposed proximate to said impeller with magnetic engagement between said ferromagnetic material to cause said impeller to rotate;
said radially extending blade when rotating directing a liquid against said at least one stationary stator blade during each rotation whereby a liquid is directed against at least said one stator blade and ejected from said outlet port upon impact with said stationary stator blade.

9. A circulator as described in claim 8 wherein said base and said perforate cover are joined by a flexible hinge whereby said perforate cover and said base are easily aligned for ease of assembly.

10. A circulator as described in claim 9 wherein said base, said flexible hinge, and said perforate cover are simultaneously formed in a molding process.

11. The apparatus as described in claim 10 wherein said cover has a spherical section shape.

12. The apparatus as described in claim 11 further including an aromatic substance disposed intermediate said impeller and said base whereby an aromatic effect is produced for users of the associated foot bath.

13. The apparatus as described in claim 11 further including a coloring substance disposed intermediate said impeller and said base whereby liquid in the associated foot bath achieves an aesthetic color impression.
